(19) United States
(12) Patent Application Publication
(10) Pub. No.: US 2023/0177757 A1
(43) Pub. Date: Jun. 8, 2023

(54) INFORMATION PROCESSING APPARATUS AND DATA STRUCTURE OF MOVING IMAGE FILE

(71) Applicant: FUJIFILM Business Innovation Corp., Tokyo (JP)

(72) Inventor: Yuzuru SUZUKI, Kanagawa (JP)

(73) Assignee: FUJIFILM Business Innovation Corp., Tokyo (JP)

(21) Appl. No.: 17/743,456

(22) Filed: May 13, 2022

(30) Foreign Application Priority Data
Dec. 2, 2021 (JP) 2021-196277

(51) Int. Cl. G06T 13/80; G06T 11/60

(52) U.S. Cl. CPC G06T 13/80; G06T 11/60

(57) ABSTRACT

An information processing apparatus includes: a processor configured to: convert a part or entirety of a first still image in a raster format into a second still image in a vector format; and based on vector data of a target region to be animated in the second still image, generate a moving image in a vector format in which at least a part of the target region is animated.

### CROSS-REFERENCE TO RELATED APPLICATIONS

This application is based on and claims priority under 35 USC 119 from Japanese Patent Application No. 2021-196277 filed Dec. 2, 2021.

### BACKGROUND

### (i) Technical Field

The present invention relates to an information processing apparatus and a data structure of a moving image file.

### (ii) Related Art

A moving image including a motion effect as a part of a still image is also called a so-called cinemagraph, and is widely used in web advertisements and the like as an image having an eye-catching effect. As a method of generating the moving image having the motion effect, a method of generating a moving image in a raster format having a motion effect from a still image or a moving image in a raster format, and a method of generating a moving image in a vector format having a motion effect from a still image in a vector format exist in the related art (for example, JP2013-156962A, JP6888098B, and JP2016-129281A).

### SUMMARY

Meanwhile, with the methods in the related art, it is difficult to convert a part of a still image in a raster format to generate a moving image in a vector format.

Aspects of non-limiting embodiments of the present disclosure relate to an information processing apparatus and a data structure of a moving image file that generate a moving image more easily than in the related art, by using vector data generated in a case of converting a still image in a raster format into a vector format.

Aspects of certain non-limiting embodiments of the present disclosure overcome the above disadvantages and/or other disadvantages not described above. However, aspects of the non-limiting embodiments are not required to overcome the disadvantages described above, and aspects of the non-limiting embodiments of the present disclosure may not overcome any of the disadvantages described above.

According to an aspect of the present disclosure, there is provided an information processing apparatus including: a processor configured to: convert a part or entirety of a first still image in a raster format into a second still image in a vector format; and based on vector data of a target region to be animated in the second still image, generate a moving image in a vector format in which at least a part of the target region is animated.

### BRIEF DESCRIPTION OF THE DRAWINGS

Exemplary embodiment(s) of the present invention will be described in detail based on the following figures, wherein:

FIG. 1 is a diagram illustrating an example of an overall configuration of an information processing system to which the present exemplary embodiment is applied;

FIG. 2 is a diagram illustrating a hardware configuration of a management server;

FIG. 3 is a diagram illustrating a functional configuration of a control unit of the management server;

FIG. 4 is a diagram illustrating a functional configuration of a control unit of a user terminal;

FIG. 5 is a flowchart illustrating a processing flow of the management server;

FIG. 6 is a flowchart illustrating a processing flow of the user terminal;

FIG. 7A is a diagram illustrating a specific example of a still image; FIG. 7B is a diagram illustrating a specific example of a data structure in a case where the still image in FIG. 7A is represented in a raster format;

FIG. 8 is a diagram illustrating a specific example of the still image in the raster format;

FIGS. 9A and 9B are diagrams illustrating a specific example of a user interface displayed on a user terminal in a case where vector data of an image of a target region converted into a vector format is processed;

FIGS. 10A and 10B are diagrams illustrating a specific example of a data structure of the vector data of the image of the target region converted into the vector format; and

FIG. 11 is a diagram illustrating a specific example of a data structure of vector data of a moving image in a vector format including an animated target region.

### DETAILED DESCRIPTION

Hereinafter, exemplary embodiments of the present invention will be described in detail with reference to drawings.

Configuration of Information Processing System

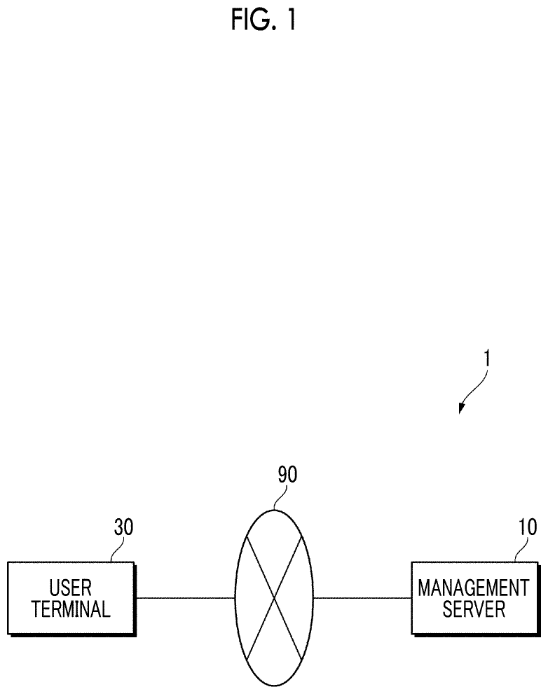

FIG. 1 is a diagram illustrating an example of an overall configuration of an information processing system 1 to which the present exemplary embodiment is applied.

The information processing system 1 is configured by a management server 10 and a user terminal 30 being connected via a network 90. The network 90 is, for example, the Internet, a local area network (LAN), or the like.

The management server 10 is an information processing apparatus as a server that manages the information processing system 1. For example, the management server 10 converts a part or entirety of a still image in a raster format transmitted from the user terminal 30 into a still image in a vector format to generate a moving image in a vector format in which based on vector data of a region to be animated (hereinafter, referred to as “target region”) in the still image, at least a part of the target region is animated. Further, for example, the management server 10 converts the target region of the still image in the raster format transmitted from the user terminal 30 into a still image in a vector format to generate a moving image in a vector format with at least a part of the target region being animated, based on vector data of the still image. Details of the processes by the management server 10 will be described below.

Here, the “raster format” is an image description format in which an image is represented by pixels having different densities or pixels of various colors, and is often used in a case of representing a complicated shadow such as a photograph. Images in the raster format are saved in file formats such as BMP, JPEG, TIFF, GIF, and PNG. Further, the “vector format” is an image description format for representing an image by vector data. The “vector data” is data representing points, lines, polygons, and the like by using coordinate values and attribute information. Images in the vector format are saved in file formats such as SVG, PDF, and HTML. In general, regarding illustrations or graphic data, the amount of data can be reduced by representing the data in the vector format rather than representing the data in the raster format. In the present specification, the expression “image” includes “image data”.

The user terminal 30 is an information processing apparatus such as a personal computer, a tablet terminal, or a smartphone operated by a user. For example, the user terminal 30 transmits a still image in a raster format toward the management server 10. Further, for example, the user terminal 30 acquires and displays a still image in a vector format transmitted from the management server 10. In addition, for example, the user terminal 30 accepts designation of a target region in the still image in the vector format, and transmits information on the designation of the target region (hereinafter, referred to as “designation information”) toward the management server 10. Further, for example, the user terminal 30 acquires and displays a moving image in a vector format transmitted from the management server 10. Details of these processes by the user terminal 30 will be described below.

Each function of the management server 10 and the user terminal 30 constituting the information processing system 1 described above is an example, and the information processing system 1 as an entirety may have the functions described above. Therefore, a part or entirety of of the function described above may be shared or cooperated in the information processing system 1. That is, the part or entirety of the function of the management server 10 may be a function of the user terminal 30, or the part or entirety of the function of the user terminal 30 may be a function of the management server 10. Further, a part or entirety of each function of the management server 10 and the user terminal 30 constituting the information processing system 1 may be transferred to another server or the like (not illustrated). As a result, the processes of the information processing system 1 as an entirety are promoted, and the processes can be complemented with each other.

Hardware Configuration of Management Server

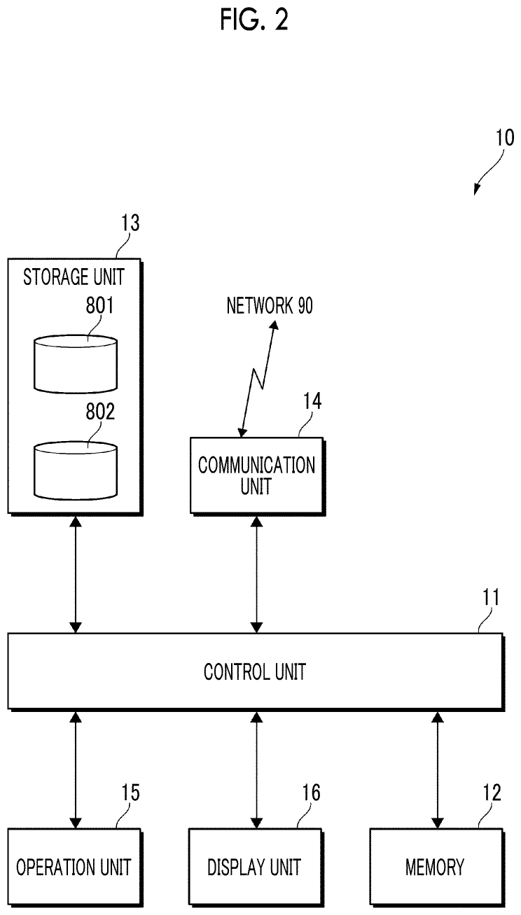

FIG. 2 is a diagram illustrating a hardware configuration of the management server 10.

The management server 10 includes a control unit 11, a memory 12, a storage unit 13, a communication unit 14, an operation unit 15, and a display unit 16. Each of these units is connected by a data bus, an address bus, a peripheral component interconnect (PCI) bus, or the like.

The control unit 11 is a processor that controls a function of the management server 10 through execution of various types of software such as OS (basic software) or application software. The control unit 11 is configured with, for example, a central processing unit (CPU). The memory 12 is a storage region for storing various types of software, data to be used for executing the software, or the like, and is used as a work area for an arithmetic operation. The memory 12 is configured with, for example, a random access memory (RAM) or the like.

The storage unit 13 is a storage region for storing input data to various types of software, output data from various types of software, or the like. The storage unit 13 is configured with, for example, a hard disk drive (HDD), a solid state drive (SSD), a semiconductor memory, or the like to be used for storing programs, various types of setting data, or the like. As a database for storing various types of information, the storage unit 13 stores, for example, an object DB 801 in which information indicating characteristics of various objects is stored, an image DB 802 in which images (still image and moving image) are stored, and the like.

The communication unit 14 transmits and receives data between the user terminal 30 and an outside via the network 90. The operation unit 15 is configured with, for example, a keyboard, a mouse, a mechanical button, and a switch, and accepts input operations. The operation unit 15 also includes a touch sensor integrally constituting a touch panel with the display unit 16. The display unit 16 is configured with, for example, a liquid crystal display or an organic electro luminescence (=EL) display to be used for displaying information, and displays data of an image or a text and the like.

Hardware Configuration of User Terminal

A hardware configuration of the user terminal 30 has the same configuration as the hardware configuration of the management server 10 illustrated in FIG. 2. Therefore, illustration and description of the hardware configuration of the user terminal 30 will be omitted.

Functional Configuration of Control Unit of Management Server

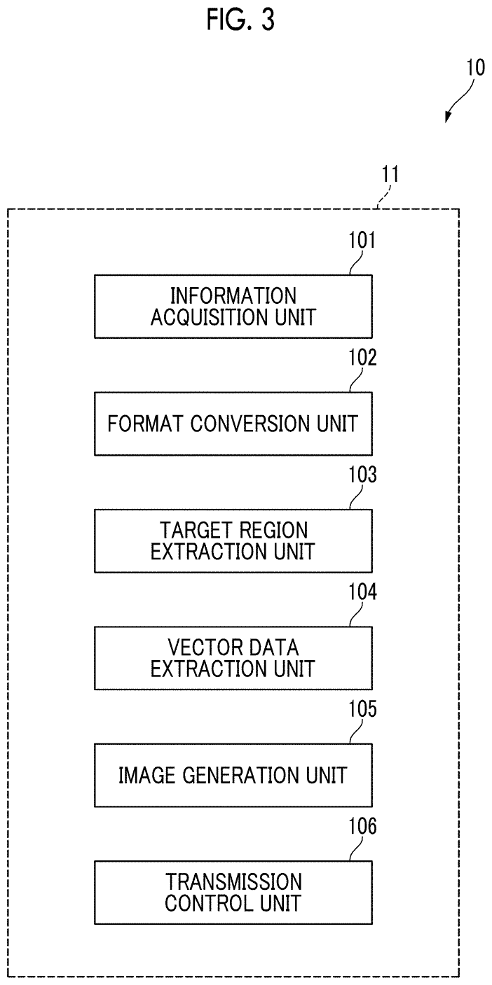

FIG. 3 is a diagram illustrating a functional configuration of the control unit 11 of the management server 10.

An information acquisition unit 101, a format conversion unit 102, a target region extraction unit 103, a vector data extraction unit 104, an image generation unit 105, and a transmission control unit 106 function, in the control unit 11 of the management server 10.

The information acquisition unit 101 acquires various types of information. For example, the information acquisition unit 101 acquires a still image in a raster format transmitted from the user terminal 30. The still image in the raster format acquired by the information acquisition unit 101 is stored and managed in the image DB 802 (see FIG. 2) of the storage unit 13. Further, the information acquisition unit 101 acquires designation information transmitted from the user terminal 30. The “designation information” means information regarding designation of a target region by a user.

The format conversion unit 102 converts a part or entirety of a format of an image (still image and moving image). For example, the format conversion unit 102 converts a part or entirety of the still image in the raster format acquired by the information acquisition unit 101 into a still image in a vector format. Further, for example, the format conversion unit 102 converts the still image in the vector format into a still image in a raster format.

The target region extraction unit 103 extracts a target region from a still image in a raster format or a still image in a vector format. In a case where designation information is acquired by the information acquisition unit 101, the target region extraction unit 103 extracts a target region specified from the designation information, from the still image in the raster format or the still image in the vector format. On the other hand, in a case where the designation information is not acquired by the information acquisition unit 101, the target region is automatically specified and extracted. Specifically, the target region extraction unit 103 analyzes the still image in the raster format or the still image in the vector format, and extract the target region from the still image in the raster format or the still image in the vector format as the analyzing target, based on the analysis result.

A part or entirety of the target region extracted by the target region extraction unit 103 includes a predetermined object. As the “predetermined object”, for example, an object of which at least one of a position or appearance is changed with the passage of time is used. The target region extraction unit 103 can also use a machine learning model using artificial intelligence (AI) in a case of extracting a target region including a part or entirety of the object of which at least one of the position or appearance is changed with the passage of time.

Examples of the “object of which at least one of the position or appearance is changed with the passage of time” included in the target region include natural objects and artificial objects. Among the natural objects and the artificial objects, the “natural object” includes, for example, the sea, rivers, mountains, lakes, waterfalls, water surfaces, steam, animals including humans, plants, clouds, shadows, smoke, rain, snow, thunder, light, and the like. In addition, as the “artificial object”, for example, buildings, automobiles, bicycles, airplanes, trains, motorcycles, gears, wheels, drinks, jellies, puddings, illumination, lights, car windows, rotating bodies, moving objects, and the like are used.

The “at least one of the position or appearance is changed with the passage of time” is a concept including a change of a shadow in appearance with the passage of time. Therefore, for example, an object that does not move by itself, or an object of which movement cannot be visually recognized even in a case where the object moves is included in the artificial object or the natural object described above, as long as the object is an object of which an appearance is changed due to light or shadow (for example, a building, a mountain, or the like).

The vector data extraction unit 104 extracts vector data of the part or entirety of the still image converted into a vector format by the format conversion unit 102. The vector data extracted by the vector data extraction unit 104 includes vector data of the target region extracted by the target region extraction unit 103.

Further, in a case where the vector data of the target region is processed, the vector data extraction unit 104 extracts attribute information respectively constituting the pieces of vector data of the target region before and after the processing. In addition, the vector data extraction unit 104 extracts a difference as a difference between the attribute information before the processing and the attribute information after the processing. As the “attribute information”, for example, path data is used.

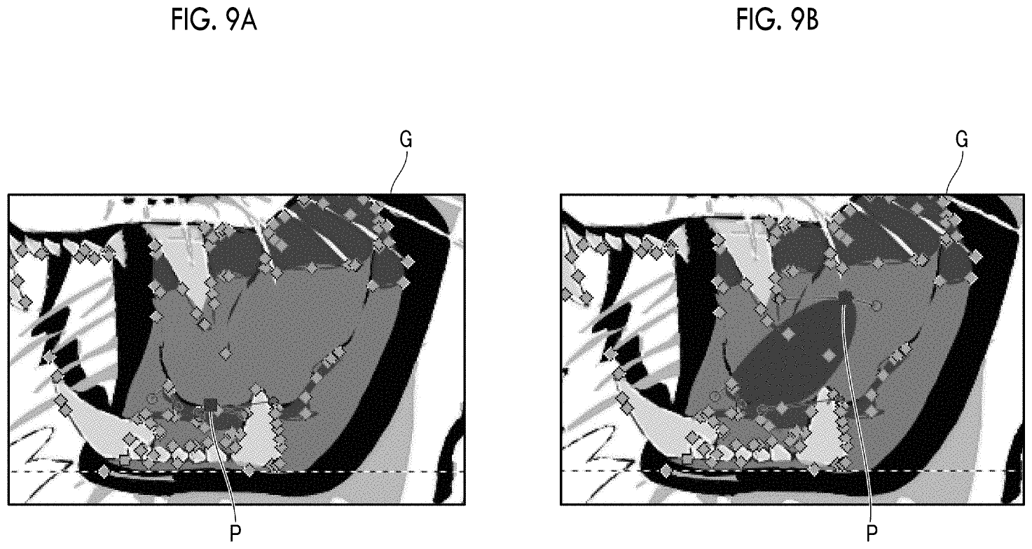

The “path data” is text string data that is a component of a part of vector data. A region surrounded by a line obtained by executing a command according to a text string of the path data is called a “path graphic”. The difference in attribute information can be acquired from, for example, a modification history of the path data. A method of processing the vector data is not particularly limited, and for example, an existing vector graphic editor or the like may be used. A specific example of processing the vector data will be described below with reference to FIGS. 9A and 9B.

The image generation unit 105 generates a moving image in a vector format in which at least a part of a target region is animated, based on the vector data of the target region included in the still image in the raster format. Specifically, the image generation unit 105 generates the moving image in the vector format in which at least a part of the target region is animated, based on a difference between vector data of the target region before the processing and vector data of the target region after the processing.

More specifically, the image generation unit 105 generates the moving image in the vector format in which at least a part of the target region is animated, based on a difference between path data as attribute information of the vector data of the target region before the processing and path data as attribute information of the vector data of the target region after the processing. In this case, the image generation unit 105 can generate the moving image in the vector format in which at least a part of the target region is animated, based on a modification history of the path data.

For example, in a case where a user modifies path data constituting vector data of a target region once, a moving image consisting of still images with two frames of a still image in a vector format including the path data before the modification and a still image in a vector format including the path data after the modification can be made. Further, for example, in a case where the user modifies the path data constituting the vector data of the target region two times, a moving image consisting of still images with three frames of a still image in a vector format including the path data before the modification, a still image in a vector format including the path data after the first modification, and a still image in a vector format including the path data after the second modification can be mode. In this manner, the moving image is generated by a plurality of still images in the vector format generated each time the path data is modified, so that it is possible to generate a smoother moving image by reducing a range of one modification of the path data and increasing the number of modifications, for example.

Further, the image generation unit 105 can modify the vector data of the target region, according to characteristics of the object of which at least one of the position or appearance is changed with the passage of time to generate the moving image in the vector format in which at least a part of the target region is animated. That is, the image generation unit 105 can automatically modify the vector data of the target region, without proposing the user for modification. In this case, since the modification is performed according to the characteristics of the object included in the target region, it is possible to suppress an unnatural moving image.

For example, in a case where an object included in a target region is an automobile, vector data of the target region is modified according to characteristics of the automobile. In this case, for example, a shape of the entire vehicle body is not changed, and the vector data of the target region is modified according to the characteristics of the automobile, such as the entire vehicle body moving back and forth due to rotations of tires. As a result, it is possible to realize a natural moving image of the object included in the target region. Information indicating the characteristics of the object used for modifying the vector data in the target region is stored in association with each object in the object DB 801 (see FIG. 2) of the storage unit 13.

The transmission control unit 106 controls to transmit various types of information toward the user terminal 30. For example, the transmission control unit 106 controls to transmit still image data obtained by converting a part or entirety of a still image in a raster format acquired by the information acquisition unit 101 into a still image in a vector format, toward the user terminal 30. Further, the transmission control unit 106 controls to transmit a moving image in a vector format in which at least a part of a target region of a still image in the vector format is animated, toward the user terminal 30.

Functional Configuration of Control Unit of User Terminal

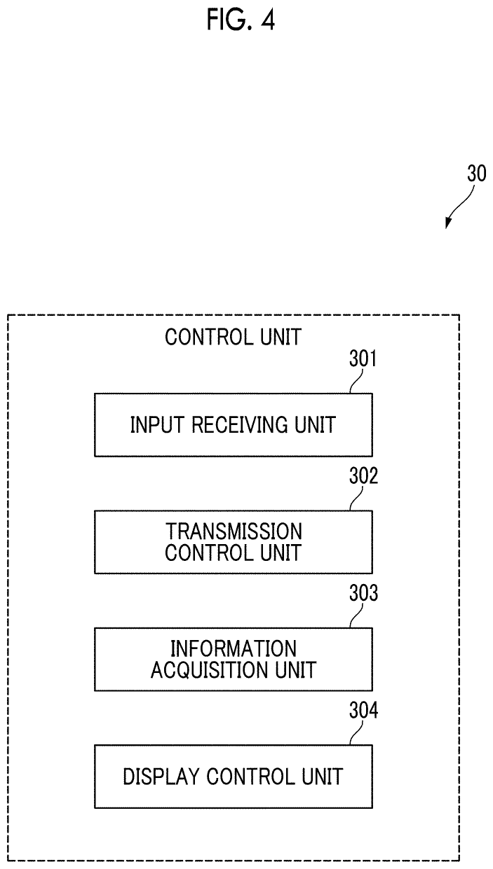

FIG. 4 is a diagram illustrating a functional configuration of a control unit of the user terminal 30.

An input receiving unit 301, a transmission control unit 302, an information acquisition unit 303, and a display control unit 304 function, in the control unit of the user terminal 30.

The input receiving unit 301 acquires information input by an operation of a user. Specifically, the input receiving unit 301 accepts an input operation for selecting a still image in a raster format to be partially animated. Further, the input receiving unit 301 also accepts an input operation for transmitting a still image in a raster format selected by the user toward the management server 10. In addition, the input receiving unit 301 accepts an input operation for designating a target region in the still image in the raster format or a still image in a vector format. Further, the input receiving unit 301 accepts an input operation for modifying vector data of the target region. Specifically, the input receiving unit 301 accepts an input operation for modifying path data as attribute information constituting the vector data of the target region.

The input receiving unit 301 accepts an input operation for processing at least a part of the target region of the still image in the vector format, as an input operation for modifying the path data. Specifically, the input receiving unit 301 accepts an input operation for changing a position or appearance of an object included in the target region. The input operation for changing the position or appearance of the object included in the target region is an operation for changing a position of an anchor of a path graphic.

For example, the input operation for changing the position of the anchor of the path graphic performed by the user may be performed via a user interface displayed on a display unit by activating dedicated application software installed on the user terminal 30, or may be performed via the user interface displayed on the display unit by accessing a dedicated website. A specific example of the input operation for changing the position of the anchor of the path graphic will be described below with reference to FIGS. 9A and 9B.

The transmission control unit 302 controls to transmit a still image in a raster format selected to be animated by an input operation of the user, toward the management server 10. Further, the transmission control unit 302 controls to transmit designation information toward the management server 10.

The information acquisition unit 303 acquires various types of information. For example, the information acquisition unit 303 acquires a still image in a vector format transmitted from the management server 10. Further, the information acquisition unit 303 acquires a moving image in a vector format in which at least a part of a target region is animated.

The display control unit 304 controls to display an image acquired by the information acquisition unit 101. Specifically, control is performed to display a still image in a vector format acquired by the information acquisition unit 101. In addition, control is performed to display a moving image in a vector format, in which at least a part of a target region is animated, acquired by the information acquisition unit 101. The display of these images may be performed via the user interface described above.

Process of Management Server

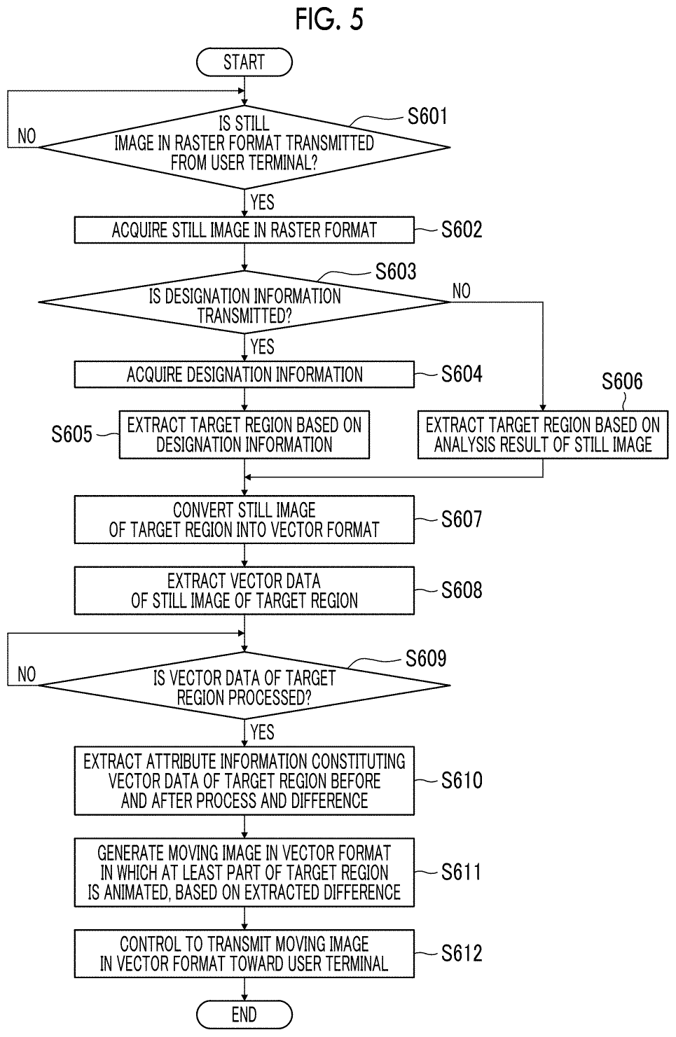

FIG. 5 is a flowchart illustrating a processing flow of the management server 10.

In a case where a still image in a raster format is transmitted from the user terminal 30 (YES in step S601), the management server 10 acquires the still image in the raster format (step S602). On the other hand, in a case where the still image in the raster format is not transmitted from the user terminal 30 (NO in step S601), the process in step S601 is repeated until the still image in the raster format is transmitted from the user terminal 30.

In a case where designation information on the still image in the raster format acquired in step S602 is transmitted (YES in step S603), the management server 10 acquires the designation information (step S604) and extracts a target region, based on the designation information (step S605). Specifically, the management server 10 extracts a target region including a predetermined object. On the other hand, in a case where the designation information is not transmitted from the user terminal 30 (NO in step S603), the management server 10 extracts the target region based on an analysis result of the still image (step S606). Specifically, for example, the management server 10 analyzes the still image in the raster format acquired in step S602, and extracts the target region including the predetermined object, based on the analysis result.

The management server 10 converts the still image of the target region extracted in step S605 or step S606 into a vector format (step S607), and extracts vector data of the still image of the target region (step S608). In a case where the vector data of the target region is processed by an input operation of the user (YES in step S609), attribute information constituting the vector data of the target region before and after the processing and a difference between pieces of attribute information are extracted (step S610). On the other hand, in a case where the vector data of the target region is not processed (NO in step S609), step S609 is repeated until the vector data in the target region is processed. The management server 10 generates a moving image in a vector format in which at least a part of the target region is animated (step S611) based on the extracted difference, and controls to transmit the generated moving image in the vector format toward the user terminal 30 (step S612).

Process of User Terminal

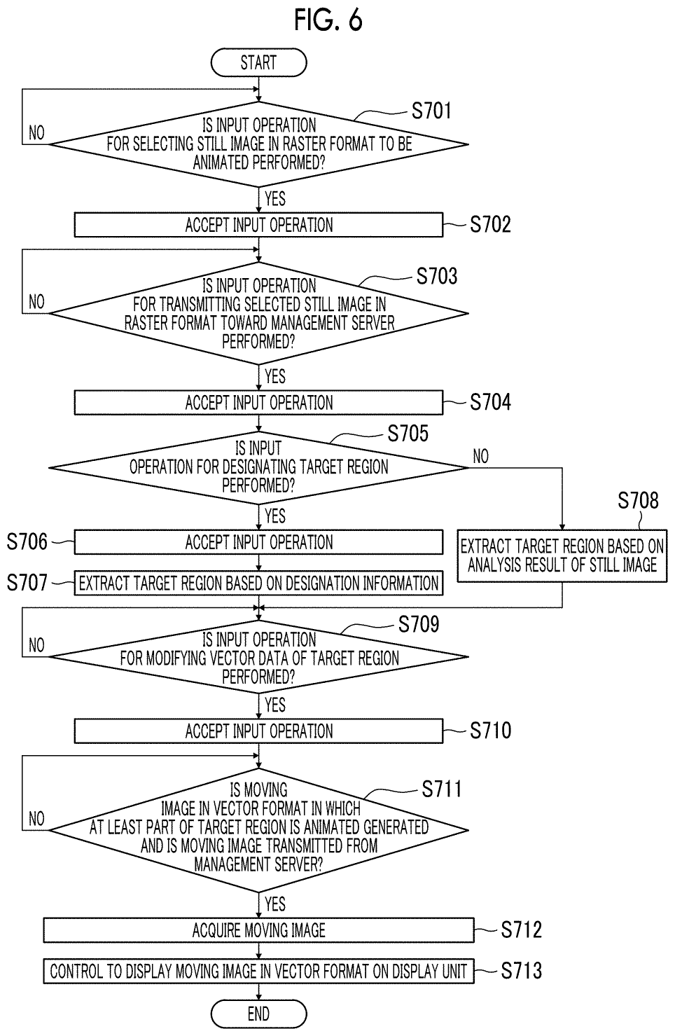

FIG. 6 is a flowchart illustrating a processing flow of the user terminal 30.

In a case where an input operation for selecting a still image in a raster format to be animated is performed (YES in step S701), the user terminal 30 accepts the input operation (step S702). On the other hand, in a case where the input operation for selecting the still image in the raster format to be animated is not performed (NO in step S701), the user terminal 30 repeats step S701 until the input operation for selecting the still image in the raster format to be animated is performed.

In a case where an input operation for transmitting the selected still image in the raster format toward the management server 10 is performed (YES in step S703), the user terminal 30 accepts the input operation (step S704). On the other hand, in a case where the input operation for transmitting the selected still image in the raster format toward the management server 10 is not performed (NO in step S703), the user terminal 30 repeats step S703 until the input operation for transmitting the selected still image in the raster format toward the management server 10 is performed.

In a case where an input operation for designating a target region is performed (YES in step S705), the user terminal 30 accepts the input operation (step S706), and extracts the target region based on designation information (step S707). On the other hand, in a case where the input operation for designating the target region is not performed (NO in step S705), the management server 10 extracts the target region based on an analysis result of the still image (step S708).

In a case where an input operation for modifying vector data of the target region extracted based on the designation information or the analysis result of the still image is performed (YES in step S709), the user terminal 30 accepts the input operation (step S710). On the other hand, in a case where the input operation for modifying the vector data in the target region is not performed (NO in step S709), the user terminal 30 repeats step S709 until the input operation for modifying the vector data in the target region is performed.

In a case where the management server 10 generates a moving image in a vector format in which at least a part of the target region is animated and the moving image is transmitted from the management server 10 (YES in step S711), the user terminal 30 acquires the moving image (step S712), and controls to display the moving image on a display unit (step S713). On the other hand, in a case where the moving image in the vector format in which at least a part of the target region is animated is not transmitted (NO in step S711), the user terminal 30 repeats step S711 until the moving image in the vector format in which at least a part of the target region animated is transmitted.

### Specific Example

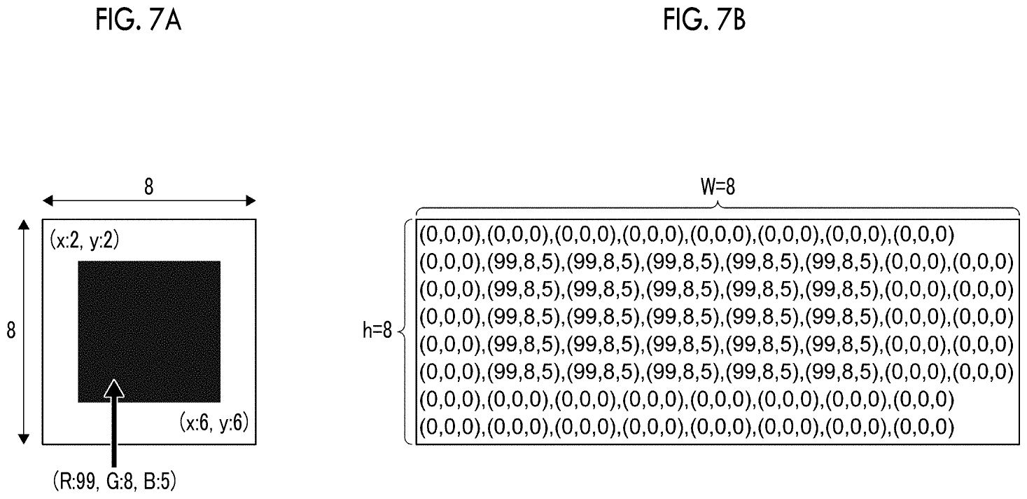

FIG. 7A is a diagram illustrating a specific example of a still image. FIG. 7B is a diagram illustrating a specific example of a data structure in a case where the still image in FIG. 7A is represented in a raster format.

The still image illustrated in FIG. 7A is an image in which a colored quadrangle is disposed in a center portion of a region indicated by another quadrangle. FIG. 7B illustrates a data structure in a case where the image in FIG. 7A is represented in a raster format. As illustrated in FIG. 7B, the raster format is a format in which an image is represented by data in which one pixel represented by an RGB color model is arranged in a vertical and horizontal grid shape. For example, “(0, 0, 0)” indicates a white pixel, and “(99, 8, 5)” indicates a colored pixel. In a case where the image represented in the raster format is enlarged, the image becomes rough and deteriorates. Therefore, in order to suppress the deterioration of the image, it is necessary to increase the number of pixels and to increase a resolution. Meanwhile, in a case where the resolution is increased, the amount of data increases accordingly.

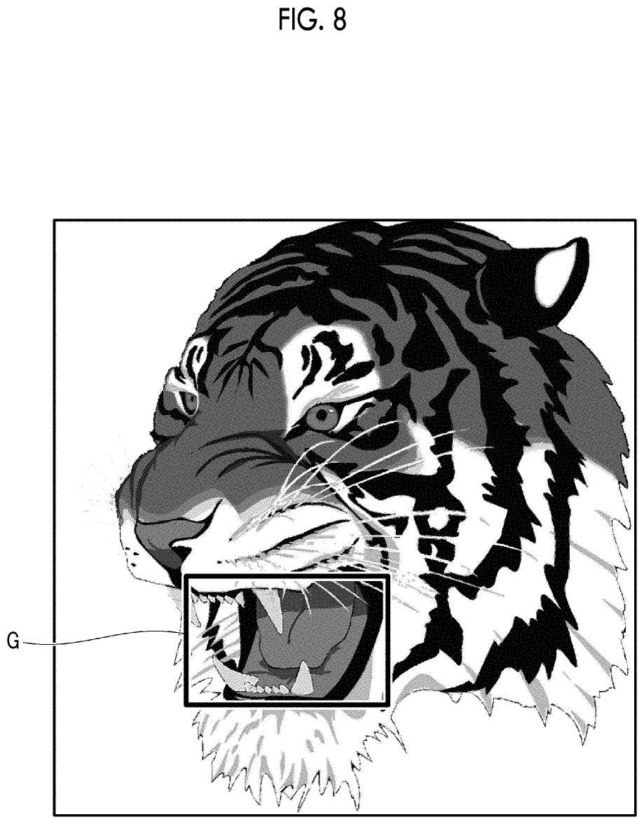

FIG. 8 is a diagram illustrating a specific example of a still image in a raster format.

The still image in the raster format illustrated in FIG. 8 is a graphic image of a tiger's head. Here, it is assumed that the user wants to incorporate a motion effect into a part of the still image in FIG. 8 and use the image for a web advertisement of a company of the user. As described above, a moving image including a motion effect as a part of a still image is also called a so-called cinemagraph, and is widely used in web advertisements and the like as an image having an eye-catching effect.

As a method of generating the moving image having the motion effect, a method of generating a moving image in a raster format having a motion effect from a still image or a moving image in a raster format, and a method of generating a moving image in a vector format having a motion effect from a still image in a vector format exist in the related art. In order to display the moving image with the motion effect as a web advertisement, web affinity appropriate for devices of various sizes is required. For example, in an image in a raster format, it is necessary to increase a resolution since the image deteriorates in a case where the image is enlarged as described above. Meanwhile, the amount of data increases accordingly, and it is not possible to secure the web affinity. On the other hand, an image in a vector format does not deteriorate even in a case where the image is enlarged, and there is a limit to a variation of eye-catching effects since the image with complex shadows requires enormous calculations to be quantified.

Therefore, in the present exemplary embodiment, as a moving image utilizing each advantage of the image represented in the raster format and the image represented in the vector format, a moving image in a vector format in which at least a part of a target region is animated is generated. Specifically, as described above, a part or entirety of the still image in the raster format is converted into the still image in the vector format, and the moving image in the vector format in which at least a part of a target region is animated is generated, based on a change of vector data indicating the target region. The moving image in the vector format generated by such a method is appropriate for simply making a moving image, and can have high web affinity and reduce the amount of data. In the example in FIG. 8, the user performs an input operation for designating a target region G indicating a mouth portion of the tiger's head. Then, an image of the target region G is converted into a vector format, and vector data is extracted.

FIGS. 9A and 9B are diagrams illustrating a specific example of a user interface displayed on the user terminal 30 in a case where vector data of an image of the target region G converted into a vector format is processed. FIG. 9A illustrates a state before the processing is performed, and FIG. 9B illustrates a state after the process is performed.

The user can use existing application software such as a vector graphic editor in a case of processing the vector data of the image of the target region G converted into the vector format. In a case where the user displays a path graphic of the target region G by using the vector graphic editor installed in the user terminal 30, for example, as illustrated in FIG. 9A, a user interface capable of editing the path graphic is displayed on the display unit of the user terminal 30.

The user performs an operation of moving a position of an anchor P of the path graphic displayed on the interface. As a result, a shape of a part of the tongue in the tiger's mouth can be changed. For example, the user can change the position of the anchor P illustrated in FIG. 9A to a position of the anchor P illustrated in FIG. 9B. As a result, the path data is modified once.

As a result of such a modification, it is possible to make a moving image by two images having the path graphic of the target region G illustrated in FIG. 9A as a first frame image, and the path graphic of the target region G illustrated in FIG. 9B as a second frame image. FIGS. 9A and 9B illustrate an example in which the path data is modified only once, and the exemplary embodiment is not limited to this, and the path data may be modified two times or more. By increasing the number of modifications, the number of still images to be used for making the moving image is increased, so it is possible to represent smoother tongue movements.

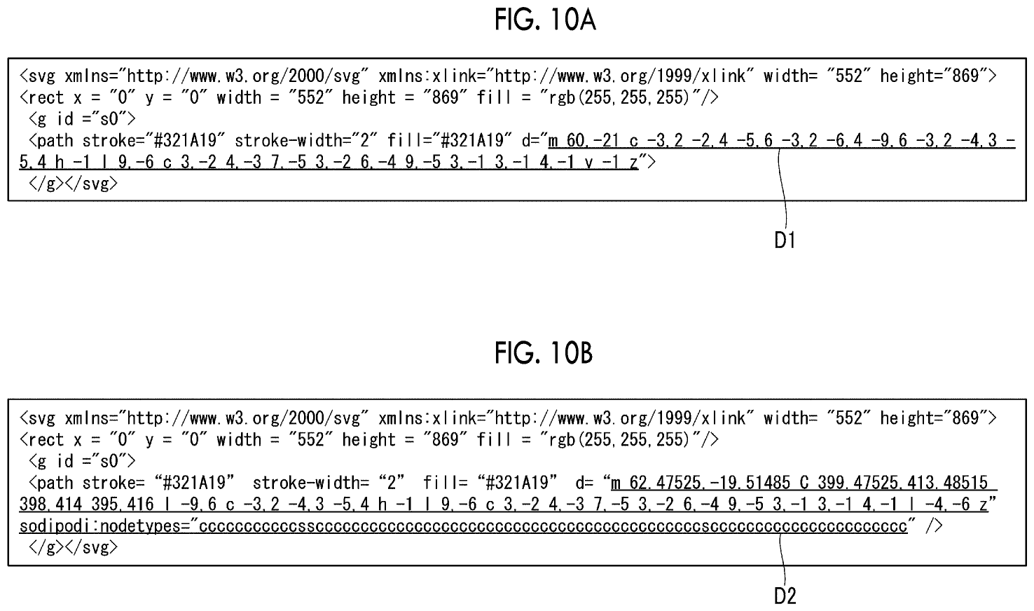

FIGS. 10A and 10B are diagrams illustrating a specific example of a data structure of vector data of an image of the target region G converted into a vector format. FIG. 10A illustrates a state before path data is modified, and FIG. 10B illustrates a state after the path data is modified.

In a case of comparing the vector data illustrated in FIG. 10A with the vector data illustrated in FIG. 10B, there is a difference in a text string of the path data. Specifically, there is a difference between a text string D1 and a text string D2 of the path data indicated by the underline. The difference is because a position of the anchor P illustrated in FIG. 9A is modified to a position of the anchor P illustrated in FIG. 9B, by the input operation of the user.

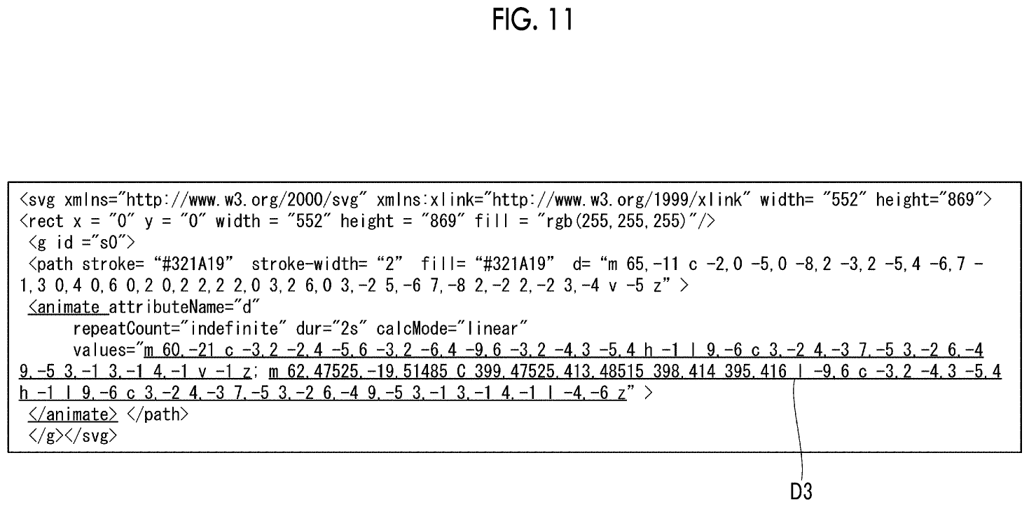

FIG. 11 is a diagram illustrating a specific example of a data structure of vector data of a moving image in a vector format including the animated target region G.

In a case where the moving image is made based on the vector data illustrated in FIG. 10A and the vector data illustrated in FIG. 10B, according to the present exemplary embodiment, the vector data illustrated in FIG. 11 is generated. A text string D3 of path data constituting the vector data illustrated in FIG. 11 is obtained by combining the text string D1 of the path data constituting the vector data illustrated in FIG. 10A and the text string D2 of the path data constituting the vector data illustrated in FIG. 10B. Therefore, the first half of the text string D3 has the same structure as the text string D1, and the second half of the text string D3 has the same structure as the text string D2.

The example in FIG. 11 is an example in which the moving image is made based on two still images obtained by modifying the path data constituting the vector data once, and the present exemplary embodiment is not limited to this. The moving image may be made based on n+1 still images obtained by modifying the path data constituting the vector data n times (n is an integer value equal to or more than 2).

Although the present exemplary embodiment is described above, the exemplary embodiment of the present invention is not limited to the above exemplary embodiment. Further, the effect of the exemplary embodiment of the present invention is not limited to the above exemplary embodiment. For example, any of the configuration of the information processing system 1 illustrated in FIG. 1 and the hardware configuration of the management server 10 illustrated in FIG. 2 is merely an example for achieving the object of the exemplary embodiment of the present invention, and is not particularly limited. Further, the functional configuration of the management server 10 illustrated in FIG. 3 and the functional configuration of the user terminal 30 illustrated in FIG. 4 are merely examples, and are not particularly limited. As long as the information processing system 1 in FIG. 1 is provided with a function capable of executing the processes described above as an entirety, a functional configuration to be used to realize this function is not limited to the examples in FIGS. 3 and 4.

Further, the order of each processing step of the management server 10 and the user terminal 30 illustrated in each of FIGS. 5 and 6 is merely an example, and is not particularly limited. Not only the processes performed in chronological order according to the order of the illustrated steps, but also the processes may not necessarily be performed in chronological order, and may be performed in parallel or individually. Further, the specific examples illustrated in FIGS. 7A to 11 are only examples, and are not particularly limited.

In the embodiments above, the term “processor” refers to hardware in a broad sense. Examples of the processor include general processors (e.g., CPU: Central Processing Unit) and dedicated processors (e.g., GPU: Graphics Processing Unit, ASIC: Application Specific Integrated Circuit, FPGA: Field Programmable Gate Array, and programmable logic device). In the embodiments above, the term “processor” is broad enough to encompass one processor or plural processors in collaboration which are located physically apart from each other but may work cooperatively. The order of operations of the processor is not limited to one described in the embodiments above, and may be changed.

The foregoing description of the exemplary embodiments of the present invention has been provided for the purposes of illustration and description. It is not intended to be exhaustive or to limit the invention to the precise forms disclosed. Obviously, many modifications and variations will be apparent to practitioners skilled in the art. The embodiments were chosen and described in order to best explain the principles of the invention and its practical applications, thereby enabling others skilled in the art to understand the invention for various embodiments and with the various modifications as are suited to the particular use contemplated. It is intended that the scope of the invention be defined by the following claims and their equivalents.

What is claimed is:

1. An information processing apparatus comprising:
a processor configured to:
convert a part or entirety of a first still image in a raster format into a second still image in a vector format; and
based on vector data of a target region to be animated in the second still image, generate a moving image in a vector format in which at least a part of the target region is animated.

2. The information processing apparatus according to claim 1, wherein the processor is configured to:
generate the moving image, based on a difference between the vector data of the target region before processing and the vector data of the target region after the processing.

3. The information processing apparatus according to claim 2, wherein the processor is configured to:
generate the moving image, based on a difference in attribute information constituting each vector data before and after the processing.

4. The information processing apparatus according to claim 3, wherein the processor is configured to:
based on a modification history of path data as the difference in attribute information, generate a plurality of third still images in a vector format, and
generate the moving image, based on the plurality of generated third still images.

5. The information processing apparatus according to claim 1, wherein the processor is configured to:
convert the target region designated by a user in the first still image into the second still image.

6. The information processing apparatus according to claim 5,
wherein the user designates the target region by using predetermined application software.

7. The information processing apparatus according to claim 1, wherein the processor is configured to:
extract the target region including a predetermined object, from the first still image, and
generate the moving image by modifying the vector data of the target region extracted and converted into the second still image.

8. The information processing apparatus according to claim 7, wherein the processor is configured to:
extract the target region including an object of which at least one of a position or appearance is changed with passage of time, as the predetermined object.

9. The information processing apparatus according to claim 8, wherein the processor is configured to:
extract the target region including at least one of a natural object or an artificial object, as the object of which at least one of the position or appearance is changed with passage of time.

10. The information processing apparatus according to claim 8, wherein the processor is configured to:
extract the target region including an object of which a shadow in appearance is changed with passage of time, as the object of which at least one of the position or appearance is changed with passage of time.

11. The information processing apparatus according to claim 8, wherein the processor is configured to:
generate the moving image by modifying the vector data according to a characteristic of the object of which at least one of the position or appearance is changed with passage of time.

12. The information processing apparatus according to claim 11, wherein the processor is configured to:
extract the target region and modify the vector data, by using a machine learning model.

13. The information processing apparatus according to claim 11, wherein the processor is configured to:
generate the moving image by modifying the vector data according to a characteristic of the object predetermined for each object.

14. The information processing apparatus according to claim 13,
wherein information indicating the characteristic of the object is stored in a database in advance in association with each object.

15. A data structure of a moving image file in a vector format processed by an information processing apparatus, the data structure comprising:
third path data consisting of first path data of a first pass graphic and second path data of a second pass graphic,
wherein in a case where the third path data is used, an animation process is executed based on the first pass graphic and the second pass graphic.

16. The data structure of the moving image file according to claim 15,
wherein the second pass graphic is an image obtained by processing the first pass graphic.

17. An information processing apparatus comprising:
a processor configured to:
accept a first input operation of converting a part or entirety of a first still image in a raster format into a second still image in a vector format;
in a case where the part or entirety of the first still image is converted into the second still image, accept a second input operation of processing a target region to be animated in the second still image; and
in a case where a moving image in a vector format in which at least a part of the target region is animated is generated, perform control of displaying the moving image.

18. The information processing apparatus according to claim 17, wherein the processor is configured to:
as the second input operation, accept an input operation of changing a position or appearance of an object included in the target region.

19. The information processing apparatus according to claim 18,
wherein the input operation of changing the position or appearance of the object included in the target region is performed by using predetermined application software.

20. The information processing apparatus according to claim 19,
wherein the input operation performed by using the application software is an operation of changing a position of an anchor of a path graphic.
